(19) United States
(12) Patent Application Publication
(10) Pub. No.: US 2002/0159252 A1
(43) Pub. Date: Oct. 31, 2002

(54) Power illuminated flag

(76) Inventor: Lono J. Kasina, Washington, DC (US)

Correspondence Address: Thomas H. Webb, 2226 Beech Wood Rd, Hyattsville, MD, 20783, US

(21) Appl. No.: 09/840,916

(22) Filed: Apr. 25, 2001

(51) Int. Cl. F21L 4/00

(52) U.S. Cl. 362/186; 362/208; 362/559; 362/253; 362/812

(57) ABSTRACT

This application relates to a novel identification and flashlight device incorporating a flag disposed to extend laterally from a transparent pole-like projection extending from the end of the battery case of a hand held miniature flashlight assembly.

The battery case encloses a pair of size AA energizer dry cells of a conventional nature in an electrical circuit including a manually actuated switch on the side or on the end thereof A miniature bulb is disposed at the outer end of a transparent pole and which pole is attached to the light emitting end of the body of the battery case and electrical circuit which includes the switch for controlling illumination of the lamp.

### BACKGROUND OF THE INVENTION

The usage of plastic extensions on small penlight type flashlights is well known in the prior art. Physicians and dentists frequently use such a device to examine a patient's back teeth or gums. This device embodies a chisel-like extension from the bulb of the flashlight as illustrated on page 43 of the catalog of National Camera, Inc. for Fall and Winter 1976.

### DESCRIPTION OF THE INVENTION

This invention relates to a flashlight type device for a novelty identification display which is illuminated by a flashlight bulb of a miniature nature which has included therewith and energized by dry battery type cells disposed within the battery case. The illumination provided by the bulb is controlled in an on/off manner by a switch provided on the battery case in a conventional manner well known to practitioners in the art.

The device preferably includes an elongated post like extension of light transmitting material such as plastic connected to the upper end of the battery case. In a penlight flashlight the bulb would protrude to the exterior of the nose end.

An object of the invention is to provide a means of illuminating a display such for example as a small flag or a logo card of a corporation or a political party, which is inexpensive to manufacture, and marketable at a reasonable price.

It is a feature of the device to provide a display device which utilizes a quick and handy means for interchanging the logo or the message to be displayed.

Other objects and features and many of the advantages of the invention will be obvious to those familiar with the art to which the flashlight device relates, or will become more apparent in view of the following description and by reference to the accompanying drawings in which the same reference characters are applied to the same parts in the various views.

### DESCRIPTION OF THE DRAWINGS

FIG. 1 is an elevation view of the device of the invention with portions thereof broken away to illustrate internal details of the battery case.

FIG. 2 is an end view looking down from the top end of the device.

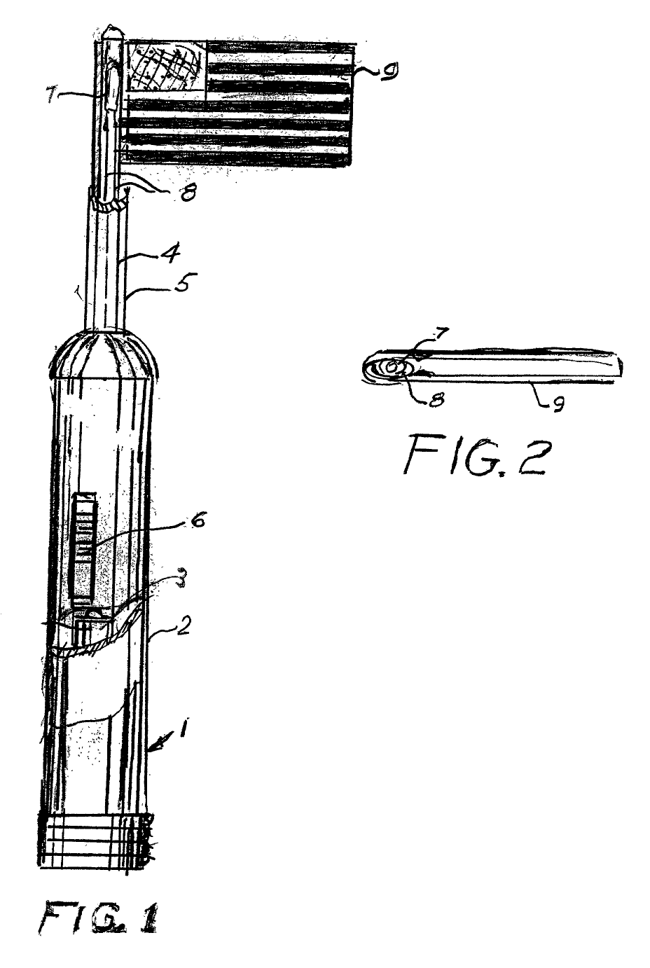

The device indicated generally at 1, comprises a battery case 2, preferably for two AA size battery cells illustrated at 3 in the cutaway portion of the battery case 2 and a light transmitting rod 4 which is enclosed for the lowermost portion of the transparent rod 4 by a light shielding cylinder 5, which extends upwardly or outwardly to the base level of the miniature lamp 7. Referring next to FIG. 2, for a showing of the manner of attaching flag or logo sleeve 9 over the end of the rod 4, it is loop shaped and is pushed down over rod 4 in order to be illuminated by light from bulb 7.

[image]

[image]

What is claimed and desired to be protected by a Letters Patent from the United States Patent and Trademark Office is:

1. In combination, in an illuminated novelty display device of the character disclosed, a penlight type flashlight characterized as utilizing a plurality of dry cell batteries, a switch in a control circuit from said batteries to an illuminating means consisting of a miniature light bulb disposed a remote distance from the flashlight and connected by wiring from said switch to said batteries, a tubular light transmitting clear plastic element connected between the uppermost end of the flashlight and the remotely disposed light bulb which is mounted over and concentric to said clear plastic element and extending to coincide with innermost end of said light bulb, and a flag like logo banner which is disposed to partially wrap around the bulb carrying portion of the clear plastic element and extend outwardly therefrom in a flowing flag manner.

2. The combination of claim 1, further comprising the structure of said banner incorporating printed intelligence.
